(19) United States
(12) Patent Application Publication
(10) Pub. No.: US 2020/0241157 A1
(43) Pub. Date: Jul. 30, 2020

(54) Real-time surface microseismic monitoring with mobile compact acquisition system

(71) Applicant: Alexander Klushin, Katy, TX (US)

(72) Inventors: Gennady Erokhin, Kaliningrad (RU); Alexandre lakovlev, Mississauga (CA); Alexander Klushin, Katy, TX (US); Oleg Shkurov, Moscow (RU)

(73) Assignee: GeoArray Technologies LLC, Katy, TX (US)

(21) Appl. No.: 16/744,458

(22) Filed: Jan. 16, 2020

Related U.S. Application Data
(60) Provisional application No. 62/797,436, filed on Jan. 28, 2019.

(51) Int. Cl. G01V 1/28; G01V 1/30

(52) U.S. Cl. CPC G01V 1/288; G01V 1/16; G01V 1/30

(57) ABSTRACT

The present invention provides methods and systems for real-time surface microseismic monitoring of a hydraulic fracture and other technical activities on the bases of the compact and mobile acquisition system. The methods provide real-time estimation of the coordinates of microseismic events, their seismic moments, as well as four types of stimulated reservoir volume based on the total energy of the events and their principal stresses.

### FIELD OF THE INVENTION

The present invention relates to the research of underground processes of artificial or natural origin connected with the formation of microcracks and, as a consequence, the release of weak seismic emission.

### BACKGROUND OF THE INVENTION

Carrying out various operations to enhance oil recovery and intensify oil production, such as multi-stage hydraulic fracturing, oil displacement, reservoir pressure support, etc., is accompanied, as a rule, by microseismic emission, which can be registered on the surface of the earth or in a well. By the nature of microseismic vibrations recorded by seismic sensors, it is possible to assess the quality and efficiency of the operations. This is the essence of microseismic monitoring.

The most important task of microseismic monitoring is, in particular, the control of multi-stage hydraulic fracturing in horizontal wells, the drilling of which is carried out on an industrial scale—one or more wells per day. Currently, there are no technologies based on low-cost, mobile (fast moving over the surface of the earth with stimulated volume projection on the surface) and, at the same time, compact recording systems whose data is collected, transmitted and processed in real time, with the results presented in principal stresses.

### SUMMARY OF THE INVENTION

Various embodiments described herein relate to the field of microseismic data acquisition and processing, and devices, systems and methods associated therewith. The present invention proposes a surface system for recording microseismic events, the distinguishing feature of which is compactness, high density of seismic sensors per unit area, and high speed of deployment and transformation (moving across the surface of the earth after drilling horizontal wells). The registration system can move directly during the registration and, thus, ensure the continuity of control, for example, a multi-stage hydraulic fracturing (rolling principle) with supporting proper quality.

The technical solutions used for high-speed wireless transmission of the present invention provide for the delivery of the data recorded by the surface microseismic system to a data processing center based on a multicore computing CPU/GPU cluster in real time.

The mathematical methods used in the invention for solving inverse kinematic and inverse dynamic problems are implemented in the form of parallel algorithms for a multicore CPU/GPU computing cluster and provide results of monitoring MHF every two minutes in a spatial parallelepiped which size is 1500×1500×300 ft and which is divided into elementary cubes (voxel) size 8×8×8 ft. In each of these elementary cubes (voxel), the following are calculated: three principal stress vectors, the magnitude and direction of the minimum and maximum horizontal stresses and three stress values: shear—DC (Double Couple component of seismic moment tensor); tensile—CLVD (Compensated Linear Vector Dipole component of seismic moment tensor); explosive or implosive—ISO (Isotropic component of seismic moment tensor).

Four Stimulated Reservoir Volumes (SRV) are calculated every five minutes: SRV Energy; SRV DC; SRV CLVD; SRV ISO.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1. is a graphical illustration of the layout of geophones for monitoring Multistage Hydraulic Fracturing (MHF) for 7 horizontal wells (scales in meters)

FIG. 2. is a graphical illustration of microseismic events induced during substitution stage, mini frac stage and main frac stage; diameter of dots representing the events corresponding to their energy; color coding corresponds to recording time: purple—substitution stage, blue—mini frac, red—main frac; SRV according the events density.

FIG. 3. is a bar chart of recorded microseismic events during Main Frac stage overlaid by operational logs (tubing pressure—red, annulus pressure—blue, fluid flow rate—green, proppant concentration by density gauge—magenta, pumping power—purple).

FIG. 4. is a graphical illustration of principal stress axes for each microseismic event during the first MHF stage; grid size is 25 meters.

FIG. 5. is a graphical illustration of SRV Energy: isosurface of energy density of microseismic events recorded during the first MHF stage; isosurface contains 95% of emitted microseismic energy; grid size is 25 meters.

FIG. 6. is a graphical illustration of horizontal slice of Energy SRV; grid size is 25 meters.

FIG. 7. is a bar chart representing percentage ratio of total emitted seismic energy to total pumping power for various MHF stages.

FIG. 8. is a bar chart representing non-compensated part of the isotropic compression and extension (P) energy for various MHF stages.

FIG. 9. is a graphical illustration of MHF microseismic monitoring results represented as energy isosurfaces (Energy SRV) and as horizontal projections of the principal stress axes.

FIG. 10. is a graphical illustration of MHF:Stage #2. Principal Stress Axes of Seismic Moment Tensor (SMT). Grid 164 ft., 354 microseismic events.

FIG. 11. is a graphical illustration of MHF:Stage #2. (DC) Double Couple Component of SMT. Grid 164 ft., SRV Energy—136128 m3. Total DC Energy 247 kJ.

FIG. 12. is a graphical illustration of MHF:Stage #2. Compensated Linear Vector Dipole (CLVD) Component of SMT. Grid 164 ft. SRV Energy—136128 m3. Total CLVD Energy 7 kJ.

FIG. 13. is a graphical illustration of MHF:Stage #2. Isotropic (ISO) Component of SMT. Grid 164 ft. SRV Energy—136128 m3. Total ISO Energy 10 kJ.

FIG. 14. is a graphical illustration of snapshots of microseismic activity cloud development over a regular 100-hour interval, grid size 10 meters.

FIG. 15. is a graphical illustration of SRV Energy: isosurfaces of energy density from microseismic events recorded in the vicinity of injection well at the hydrocarbon field during 15 days; grid size is 100 m; isosurface contains 98% of the microseismic emission energy; black line—vertical borehole.

FIG. 16. is a graphical illustration of SRV Energy: Isosurface of the energy density of the microseismic events registered in the zone of the injection well of the hydrocarbon deposit within 15 days of observation; grid size is 100 m; isosurface contains 98% of the microseismic emission energy; black line—vertical bore hole.

FIG. 17. is a daily injection volumes diagram (green) and overlaid bar chart of non-compensated part of deformation energy of isotropic extension (blue) (a); injection pressure diagram (purple) and overlaid bar chart of maximum adhesive tension (red) (b).

FIG. 18. is a graphical illustration of color-coded map of producing wells drainage zone, warmer colors correspond to greater intensity of microseismic events.

FIG. 19. is a graphical illustration of microseismic events used for delineation of the fault block structures near the vertical producing well; red line—well-bore trajectory.

FIG. 20. is a graphical illustration of microseismic events recorded during MHF and passive monitoring (purple-colored). Scattered waves cube section along the seismic line passing through the horizontal well. Tight-oil formation.

FIG. 21. is a graphical illustration of structural map demonstrating faults and microseismic events recorded during MHF and during the passive monitoring after MHF (purple-colored). Tight-oil formation.

### DETAILED DESCRIPTION OF THE PREFERRED EMBODIMENTS

Illustrative embodiments and aspects of the invention are described below. It will, of course, be appreciated that in the development of any such actual embodiment, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

The basis of the present invention is the use of weak microseismic waves generated by stresses and micro-discontinuities of natural or artificial nature arising in the medium. The signal from such sources weakens with distance and comes to different points of the surface antenna with different time delay and different amplitude (Urbancic et. al., 2003; Grechka et. al., 2017; Maxwell, 2014; Duncan et. al., 2006). Based on the use of a mathematical model of the source, described by the seismic moment tensor and involving methods for solving inverse and ill-posed problems of mathematical geophysics, it is possible to find the true kinematic and dynamic characteristics of the source, which is the main distinction of this method.

Seismoacoustic emission occurs in the geological environment due to the relaxation release of elastic stresses by spontaneous deformations of the medium, often associated with discontinuity. The process of changing elastic stresses is associated both with natural factors, mainly caused by the geodynamics of the environment (tectonic movements, sedimentation, lunar—solar tides, etc.), and with the influence of various man-made influences. The emission resulting from anthropogenic impact is the response of the environment and is called induced seismic activity.

The main man-made impacts on the reservoir during the development process are fluid extraction, water or steam injection into the reservoir, etc., which alter the stress state of the matrix of the mineral skeleton of the reservoir and the rocks enclosing it. As a result, inelastic deformations occur, accompanied by the emission of seismic waves—microseismic emission is observed.

A powerful anthropogenic impact on the reservoir is hydraulic fracturing, which brings the stress-strain balance out of equilibrium. When the medium passes to a new stable state, the energy of elastic deformations is released, accompanied by crack formation and seismic radiation. Sources of microseismic emission appear, usually confined to the bottomhole formation.

Records of seismic emission, recorded by the antenna located on the surface of the day above the bottomhole, allow to allocate in the space zones of increased activity, analyze the intensity and evaluate its correlation with technological processes.

Microseismic monitoring of oil fields is a modern technology for the study of fluid migration processes that occur during the development of oil reservoirs. The purpose of these studies is to optimize the location of production and injection wells and increase the oil recovery factor.

The technology consists of scanning microseismic data of vibrations of the surface of the earth—microseismic emissions which result from carrying out technical measures to increase the oil recovery rate in the development of oil reservoirs, with the subsequent processing of the recorded information using original software.

The results of processing are the spatial coordinates of the focal centers of microseismic emission, the components of the seismic moment tensor, the time of their occurrence and intensity. A typical recording system consists of a set of geophones embedded in the ground. The area covered by such a grid is about 1 km.

Microseismic data processing is based on solving the inverse problem of determining the sources described by the seismic moment tensor. The the inverse problem solutions are:
3D coordinates and response time of sources,
the magnitude of the shear stress at discontinuity of the medium,
amount of transformational change in volume.

These solutions allow you to build:
distribution maps of seismic events and their change over time,
distribution of microstresses by energies (including separately by hydrostatic energy, shear energy and separation energy),
directions of the axes of the principal stresses of the seismic moment tensor for each event,
stimulated reservoir volume (SRV),
fractured volume prediction with geomechanical constraints.

The spatial distribution of the sources of microseismic events and their development over time allows us to determine the channels of fluid migration. This information makes it possible to optimize the location of production and injection wells and increase the oil recovery factor.

A correct mathematical formulation in the form of an inverse problem of determining the seismic moment tensor of an arbitrary type changing over time and supercomputer information processing methods allows solving the problem of creating an effective system for controlling the development of hydrocarbon deposits more accurately and at a new qualitative level.

A feature of this technology, which favorably distinguishes it from the traditionally used downhole technologies for monitoring field development processes, is the ability to identify and map fracture zones using surface observation antennas, without using observation wells. This significantly reduces the cost of work, since there is no need to stop the wells for the time of monitoring and additionally incurring costs for lowering special equipment into them.

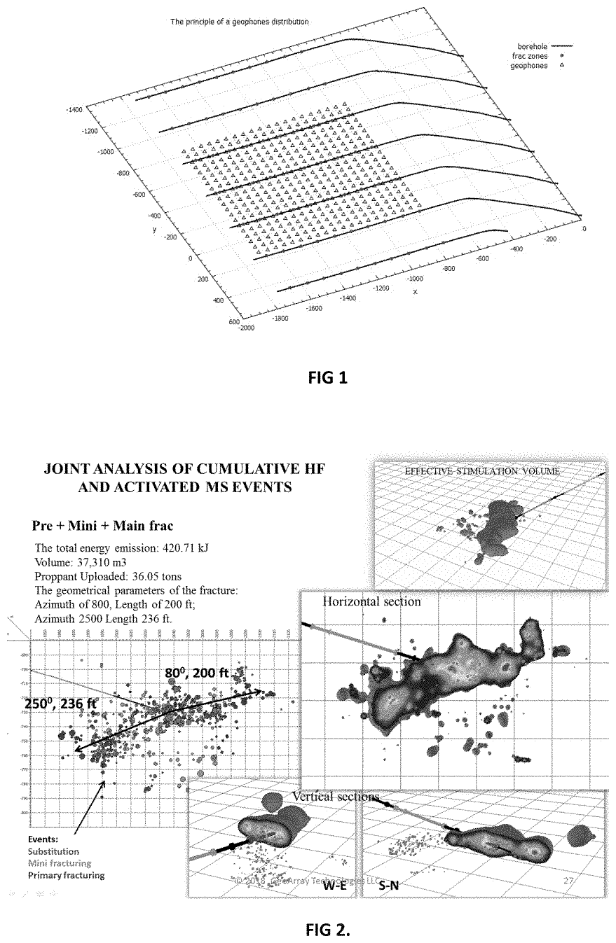

FIG. 1 shows a typical layout of geophones on the surface of the earth. A seismic antenna is installed on the day surface at the epicenter of the bottom of the well, in which hydraulic fracturing measures are designed. The location of each sensor of a seismic antenna is associated with a “Trimbler” differential GPS receiver with an accuracy of 1 ft. The dimensions of the receiving surface antenna are a square with a side of 3000 ft. Sensor density of at least 2 sensors/acre. Despite the fact that FIG. 1 shows a regular presentation, the sensors of the receiving surface antenna are preferably located on the surface on an irregular grid with an average distance between the sensors from 90 ft to 150 ft. Arrangement of antennas with a large aperture for solving the inverse kinematic problem is not advisable due to the presence of azimuthal anisotropy of the elastic properties of the geological space.

Distinctive features of this technology are high mobility, fast deployment time, high resolution, low cost of receiving, transmitting and processing microseismic data. An important feature of the technology is the principle of the roller, that is, the possibility of continuous movement of the antenna along a number of horizontal wells without stopping its operation (FIG. 1). The transfer time of 10% of the total number of microseismic antenna sensors to new antenna points does not exceed 1 hour. The guaranteed area of microseismic monitoring in the initial phase (without displacement) is an area of 6000×6000 ft and a depth of 16000 ft. (At FIG. 1-7 horizontal wells up to 3000 ft long).

Registration is carried out synchronously with all sensors with satellite time reference to technological processes of operations with a sampling rate of time from 0.25 to 1 ms. Modern equipment allows continuous registration of microseismic signals by a large number of channels for a long time with simultaneous transmission of information to the information collection server in real time. The use of wireless data transmission technology provides the mobility of the movement of the antenna (the principle of the roller).

Registration of information (prior to the start of work on the multi-stage hydraulic fracturing) is used to assess the observed background of microseismic emission on the surface in the bottomhole area. Information in the process of hydraulic fracturing with a time reference with technological processes characterizes the change of microseismic emission in the process of rupture, injection of fluid, proppant, etc. Information after fracturing is characterized by relaxation processes occurring in the medium.

The records of the seismic antenna are processed using the methods of solving the inverse kinematic problem, which allow detection of microseismic events, and then determine the coordinates of the sources of seismic emission, and the time of occurrence of events. Then these sources are located in space with reference to the bottom of the well and its wellbore. For the identified sources of microseismic emission, the inverse dynamic problem is then solved—the seismic moment tensor is calculated, on the basis of which the hydrostatic expansion, shear and separation energies are determined for each specific event.

In this invention it is assumed that the full seismic emission is a set of elementary emissions (signals), each of which has a duration of not more than 50 ms. Each signal is generated by an elementary event, which is characterized by its coordinates in space, the start time, its energy and individual characteristics of radiation in space (RU No. 2278401, 2004; RU No. 2309434, 2007; RU No. 2319177, 2008; RU No. 2618485, 2017).

Based on such assumptions, the overall task of microseismic monitoring is decomposed into a consistent solution of the following subtasks:
1. Search for the realization of an elementary event in the recorded oscillations of seismic antenna sensors.
2. The solution of the inverse kinematic problem for an elementary event (determination of the coordinates and time of the beginning of the event).
3. Solution of inverse dynamic problems for an elementary event (determination of the seismic moment tensor)
4. Assessment of the macroparameters of the environment in a certain volume based on a set of elementary parameters of events in this volume (energy, SRV, etc.)

The solution of the first problem is based on the mass cross-correlation of the antenna signals. The search for the mutual correlation function is carried out at each sample of the reference channel. As a result, the subsequent value of the mutual correlation function can be obtained from the previous one using a total of 6 multiplication operations.

\tilde{C}_{k,l}ⁱ⁺¹(j)=\tilde{C}_{k,l}ⁱ(j)−x_{k,i}x_{l,i-j}+X_{k,i+N+1}x_{l,i-j+N+1}

Eₘⁱ⁺¹(j)=Eₘⁱ(j)−x_{m,i-j}x_{m,i-j}+x_{m,i-j+N+1}x_{m,i-j+N+1}

C_{k,l}ⁱ⁺¹(j)=\tilde{C}_{k,l}ⁱ⁺¹(j)/\sqrt{Eₗⁱ⁺¹Eₖ^{i-j+1}}, (1)

where \tilde{C}_{k,l}ⁱ(j) unnormalized correlation of signals on k-th and l-th channels with shift on i-th iteration, C_{k,l}ⁱ(j) normalized correlation Eₘⁱ(j)-signal energy in a window of length N for m-th channel on i-th iteration, shifted relative to the reference channel j by samples x_{k,i}-i-th signal count on the k-th channel.

The solution of the problem of correlation search for arrival times of signals is advisable to make using the iterative approach presented above (1). In this case, it is advisable to divide temporary records into areas, which will be processed in parallel.

To solve the second problem—determining the coordinates of a microseismic event, an algorithm is used that minimizes the functional (2)

$$Δ ( x , y , z , {V}_{cp} ) = {\sum }_{k = 1 , k \neq l}^{n} {d}_{k , l} {\{ {T}_{k , l} ( x , y , z , {V}_{cp} ) - {τ}_{k , l} \}}^{2} {\to }_{ x , y , z , {V}_{cp }} min , \qquad ( 2 )$$

where T_{k,l}(x.u.z.V_{cp})-calculated relative to the reference channel l the expected delay in the arrival of the signal on the k-th channel for an event localized at x,y,z,V_{cp} a 4-dimensional space (source)

$${T}_{k , l} ( x , y , z , {V}_{cp} ) = \frac{{R}_{i} - {R}_{k}}{{V}_{cp}} ,$$

Rⱼ the distance between the source and j-th observation channel, τ_{k,l}—the observed time delays are calculated based on the mutual correlation function

$${C}_{k , l} ( τ ) = {\sum }_{j = 1}^{N} {x}_{k} ( {t}_{j} ) {x}_{i} ( {t}_{j} - τ ) {σ}_{k}^{- 1} {σ}_{l}^{- 1} , {σ}_{i}^{2} = {\sum }_{j = 1}^{N} {x}_{i}^{2} ( {t}_{j} ) , \\ {d}_{k , l} = \{ \begin{matrix}{C}_{k , l} ( τ ) , & {max}_{τ} {C}_{k , l} ( τ ) \geq λ \\ 0 , & {max}_{τ} {C}_{k , l} ( τ ) < λ\end{matrix}$$

n—is the number of receiving channels in the seismic group, N—is the length of the correlation processing window.

Using the correlation method for determining the occurrences of events with the subsequent solution of the problem by minimizing the functional (1) allows us to obtain the best characteristics of the accuracy of the location of microseismic events compared to the commonly used Passive Seismic Emission Tomography (PSET) method (Duncan et. al., 2006, Eisner et. al., Kushnir et. al., 2014).

From the point of view of mathematical statistics, the efficiency of using the PSET algorithm for detecting and locating sources for small signal-to-noise ratios can be justified only under the assumption that additive random noises affecting various sensors of a group are white noises both in time and in space (Kushnir A. F., 2014). Thus, discrete time samples of the noise components of a group's seismograms have the same dispersions, are not correlated with each other in each of the seismograms, and are not mutually correlated for the seismograms of various sensors of the group. Only in this case, the output signal-to-noise ratio (SNR) of the Semblance functional (the ratio of its average value to the variance at values of its arguments equal to the true coordinates of the source) is \sqrt{MT} much larger than the SNR in the seismograms of individual sensors of the group (where M is the number of sensors groups, T—microseismic signal duration). In this case, the use of a group of sensors reduces the threshold SNR of microseismic events detected by the PSET in \sqrt{MT} comparison with the threshold SNR when events are detected by a single sensor.

However, numerous studies of seismic noise properties at sites where MHF is produced show that real noise is not significantly stationary and correlated both in time and in space. This is due to the technogenic nature of the noise caused by the operation of the mechanisms providing technological operations of the multi-stage hydraulic fracturing.
The basis for solving the inverse kinematic problem is the functional (2) transformed to the form (3).

$$Δ ( x , y , z , {V}_{cp} ) = F ( \vec{x} ) = {‖ \vec{f} ( \vec{x} ) ‖}^{2} + T ( \vec{x} ) + P ( \vec{x} ) = {\sum }_{k}^{n} {f}_{k}^{2} ( \vec{x} ) + SH ( \vec{x} ) + P ( \vec{x} ) = {\sum }_{k = 1 , k \neq l}^{n} {[ \sqrt{{d}_{k , l}} \{ {T}_{k , l} ( \vec{x} ) - {τ}_{k , l} \} ]}^{2} + {\vec{α} ( \vec{x} - {\vec{x}}^{0} )}^{2} + {\vec{β} ( \vec{x} - {\vec{x}}^{0} )}^{p} {\to }_{ \tilde{x} } min \qquad ( 3 )$$

where

$$\{ {J}_{k , l} = \frac{\sqrt{{d}_{k , l}}}{{x}_{4}} ( \frac{{x}_{i} - {c}_{i}^{l}}{{R}_{l}} - \frac{{x}_{i} - {c}_{i}^{k}}{{R}_{k}} ) , i = 1 … 3 ; {J}_{k , 4} = \frac{\sqrt{{d}_{k , l}}}{{x}_{4}^{2}} ( {R}_{l} - {R}_{k} ) \}$$

—Jacobi matrix, cᵢ^{j}—i-th coordinate j-th receiver, ∥\vec{f}(\vec{x})∥²—functional of the form (3), T(\vec{x})—Tikhonov stabilizer, P(\vec{x})—penalty functional.

For minimization, the method of gradient descent with simplified Hessian is used, which is defined by formula (4) and the type of gradient is reflected in formula (5).

H(\vec{x})≈2J^{T}(\vec{x})J(\vec{x})+H₁(\vec{x})+H₂(\vec{x}),

Where H₁(\vec{x})ᵢⱼ=2αᵢ, H₂(\vec{x})ᵤ=p(p−1)(xᵢ−xᵢ⁰)^{p-2}. (4)

∇F(\vec{x})=2J^{T}(\vec{x})\vec{f}(\vec{x})+2\vec{α}(\vec{x}−\vec{x}⁰)+p(\vec{x}−\vec{x}⁰)^{p-1} (5)

According to the Gauss-Newton method, the next direction \vec{p} to the minimum of the functional is determined from system (6):

\vec{p}=−H⁻¹(\vec{x})F(\vec{x}). (6)

An important tool to increase the amount of information received from seismic observations is to attract more complex mathematical models to the mechanism of an earthquake. For this purpose, we apply the theory of the equivalent strength of seismic waves and the theory of the seismic moment tensor (Aki and Richards, 1980). The essence of these theories is that various mechanisms of deformation of the medium (discontinuities of a certain volume, shear breaks, etc.) can be described, from a mathematical point of view, using the equivalent source model formulas. The theory of generalized functions is widely used to describe sources.

The solution of the third subtask—the inverse dynamic problem, is based on the system of Lame equations of the form:

$$\frac{\partial {σ}_{ij}}{\partial {x}_{j}} - ρ \frac{{\partial }^{2} {u}_{i}}{\partial {t}^{2}} = \frac{\partial }{\partial {x}_{j}} {σ}_{ij}^{0} ( x , t ) \qquad ( 7 )$$

Here i, j=1,2,3, x,y∈R³; t∈R¹; ρ—is the density of the medium, σᵢⱼ—the stress tensor associated with the displacement vector u(x,t)=(u₁,u₂,u₃) in the form

$${σ}_{ij} = μ ( \frac{\partial {u}_{i}}{\partial {x}_{j}} + \frac{\partial {u}_{j}}{\partial {x}_{j}} ) + λ {δ}_{ij} \frac{\partial {u}_{k}}{\partial {x}_{k}} \qquad ( 8 )$$

where λ,μ—are Lame constants, and the repetition of indices means summation, and σ⁰_{ij(x,t)}—and is the stress of a fault, which has the form

σ⁰ᵢⱼ=Mᵢⱼ(t)δ(x−y) (9),

where i,j=1,2,3 y∈R³, δ(x)—is the generalized Dirac function of zero order, Mᵢⱼ(t)—, is a second-order symmetric tensor. Mᵢⱼ(t) called the seismic moment tensor. The tensor Mᵢⱼ(t) has the dimension of units of energy. (g·cm²·s⁻¹). The dimension of the generalized function δ(x)−1/sm³. The vector Y describes the coordinates of the earthquake source.

In terms of equivalent forces, the seismic moment tensor can describe shear discontinuity, shear destruction of the medium, transformational change in volume, separation fracture, etc. (Aki and Richards, 1980). A mathematical exposition is formulated as follows. The Lame system of equations (7)-(9) is considered. The parameter t₀ characterizes the initial moment of the process in the focus (Mᵢⱼ(t)≡0, t<t₀). Let λ,μ [symbol] ρ—known values.

Thus, in the formulation (7)-(9), the inverse kinematic problem consists in determining the parameters t₀,y, and the inverse dynamic problem consists in finding a symmetric tensor Mᵢⱼ(t) from the data

vₖ(t)=u(xₖ,t)+εₖ(t), k≥4. (10)

here xₖ∈R³, εₖ—, noise with a normal distribution probability, zero mean, and a known covariance matrix G_{ε}(xₖ,x_{k′}).

The solution of the inverse dynamic problem is based on the minimization of the quadratic residual between the observed field (10) and the model one. Such problems are related to classical incorrect and unstable problems of mathematical physics, therefore, the regularization method (Tikhonov stabilizer) and the method of choosing optimal regularization parameters based on the residual method are used to solve problem (7)-(10)—(Erokhin et. al., 1987; Anikonov et. al., 1997; Erokhin et. al., 2002; Erokhin et. al., 2014).

The solution of the fourth subtask to assess the macroparameters of the environment based on a set of solutions for elementary events is based on the well-known decomposition of the total stress into shear stress, separation and hydrostatic stress. This is possible, for example, on the basis of the reduction of stresses at each instant of time to the directions of principal stresses. These stresses are determined by the eigenvectors p(t)=(p₁(t), p₂(t), p₃(t)) of the tensor Mᵢⱼ(t) (Novatsky, 1975):

$${M}_{ij} ( t ) - {M}_{ij}^{′} ( t ) = [ \begin{matrix}{a}_{1} ( t ) & 0 & 0 \\ 0 & {a}_{2} ( t ) & 0 \\ 0 & 0 & {a}_{3} ( t )\end{matrix} ] , \\ {a}_{1} ( t ) > {a}_{2} ( t ) > {a}_{3} ( t ) .$$

Further interpretation is possible on the basis of separation from the tensor, M′ᵢⱼ(t), the isotropic tensor and deviator:

$${M}_{ij}^{′} ( t ) = \frac{1}{3} [ \begin{matrix}{p}_{0} & 0 & 0 \\ 0 & {p}_{0} & 0 \\ 0 & 0 & {p}_{0}\end{matrix} ] + [ \begin{matrix}{a}_{1} - \frac{1}{3} {p}_{0} & 0 & 0 \\ 0 & {a}_{2} - \frac{1}{3} {p}_{0} & 0 \\ 0 & 0 & {a}_{3} - \frac{1}{3} {p}_{0}\end{matrix} ] , \\ {p}_{0} ( t ) = {\sum }_{k = 1}^{3} {a}_{k} ( t ) .$$

From here, on the basis of the extremal problem of shear stress σ(t) (Novatsky, 1975), we can determine the normal vector n(t) to the planes of maximum shear stresses, σₘₐₓ^{τ}(t), and separate stresses σⁿ(t), which are defined as follows:

$${σ}_{max}^{τ} ( t ) = \frac{{a}_{1} ( t ) - {a}_{3} ( t )}{2} , {σ}^{n} ( t ) = \frac{{a}_{1} ( t ) + {a}_{3} ( t )}{2} .$$

In contrast to similar works, where the parameters of seismic emission sources are determined within the framework of a simplified mathematical model, a more correct mathematical formulation of the inverse problem (such as the problem of determining the seismic moment tensor of an arbitrary type changing over time), as well as the use of supercomputer information processing methods allow for a more accurate and new qualitative level, to solve the problem of creating an effective system for monitoring the development of hydrocarbon deposits.

Microseismic monitoring at the field is used in the analysis of both fast processes, such as MHF, and in the monitoring of slow processes: oil displacement, determining the displacement profile in the reservoir support system, well bottomhole treatment, gas lift, tracking the hydrodynamic coupling production wells, determination of flows in intercolumns at the emergency, etc.

The results of microseismic monitoring associated with the analysis of fast processes provide information about the occurrence and spread in space and time of cracks associated with the anthropogenic impact on the formation (distribution maps of registered microseismic events).

The energy density maps (isosurfaces) provide information to the interpreter to determine the areas of the most intense fracturing and thereby the areas of maximum stimulation—SRV (Stimulated Reservoir Volume). The directions of the principal axes of the seismic moment tensor provide information on the direction of the fracture. By combining these data with data on the geological structure of rocks, one can judge the correctness of technological measures, as a result of which this fracture has arisen, which makes it possible to carry out operational analysis, control and adjustment of technological operations.

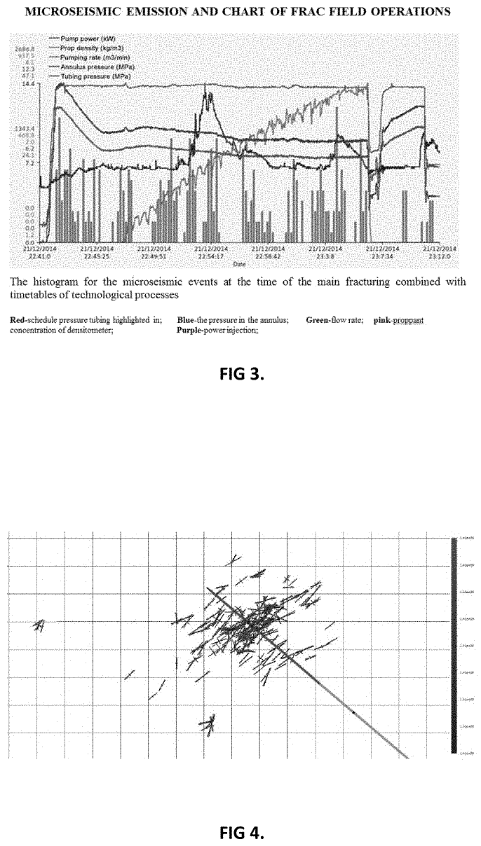

One of the key tasks of hydraulic fracturing monitoring is to identify the geometry of the fracturing zone that was developed during well simulation. Microseismic provides critical parameters such as length and azimuth of fracturing zone that can be assessed with regard to the position of hypocenters of microseismic events developed during monitoring. An example of the fractured zone mapping and determination of the azimuth of the fracture volume is distributed is shown in FIG. 2. Additional information about the fracturing process can be obtained with visualization technologies that provide valuable insights into fractured zone formation and distribution processes using both static images and time lapse—FIG. 3.

Each microseismic event can be described by a set of parameters. Apart from the event coordinates and the occurrence time, relevant energy parameters can be calculated (absolute energy, magnitude, energy of isotropic compression/extension, energy of maximal separation/compression/shear tension, etc.). Energy parameters are calculated based on the seismic moment tensor which can be represented in the principal axes as three perpendicular vectors. FIG. 4 represents microtensions distribution in the area of microseismic emission development with main tension axes directions (seismic moment tensor) during the first stage of multistage hydraulic fracturing (MHF) operations. The figure shows the maximum value of the seismic moment tensor; its length is proportional to the energy.

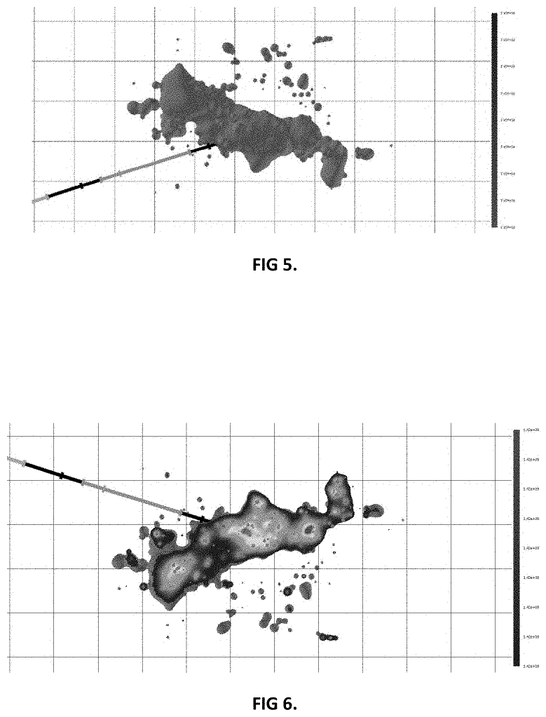

Calculation of the nmicroseismic events density allows delineation of the microseismic activity zone, so called Stimulated Reservoir Volume (SRV)—FIG. 5. The section of this zone shows the density of microseismic energy (FIG. 6).

Comparative Characteristics of the MHF Stages.

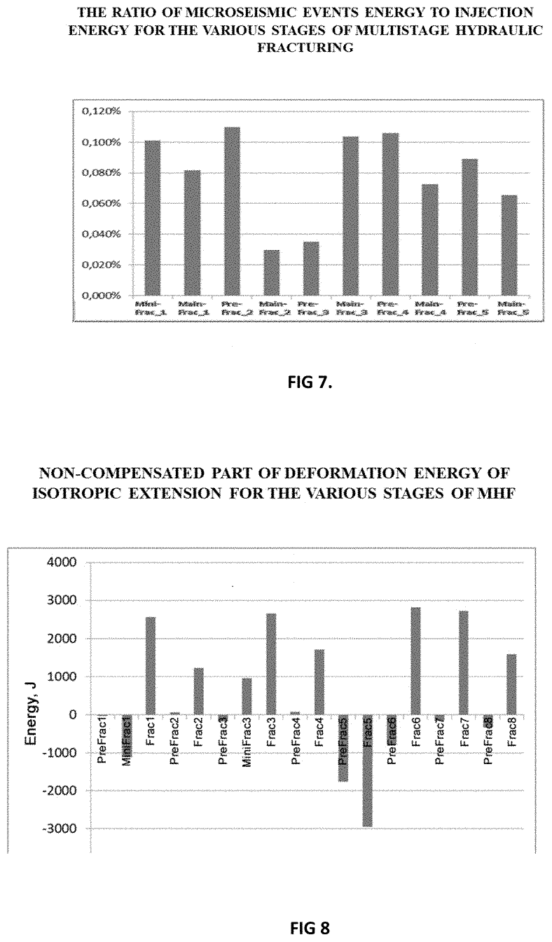

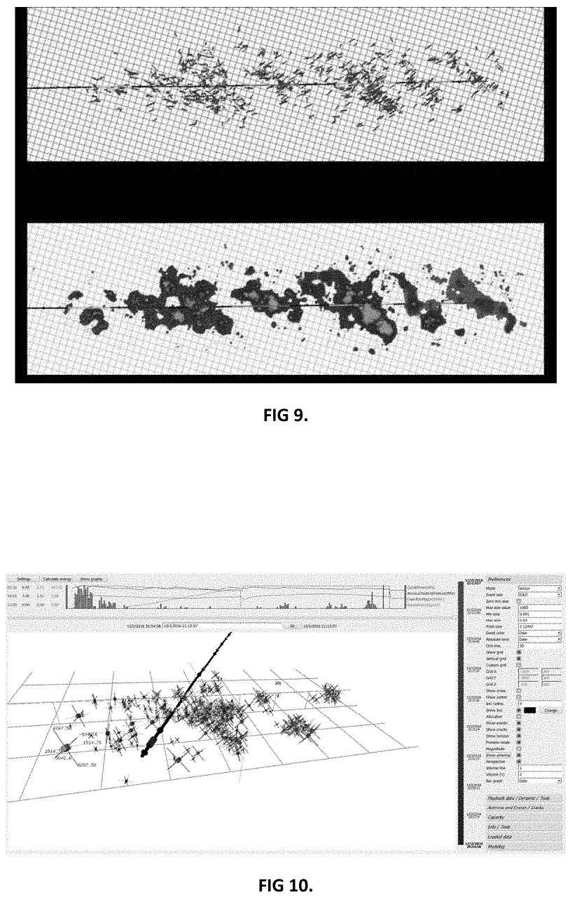

Pumping power is assessed using operational logs (FIG. 3). The total pumping power assessment and relations of microseismic energy and total pumping power characterize various stages of hydraulic fracturing process and allows comparison of this data. FIG. 7-8 shows disproportion between isotropic compression and extension (P) energy for various MHF stages. FIG. 9 shows comparative results of different stages of the 7-stage hydraulic fracturing operations.

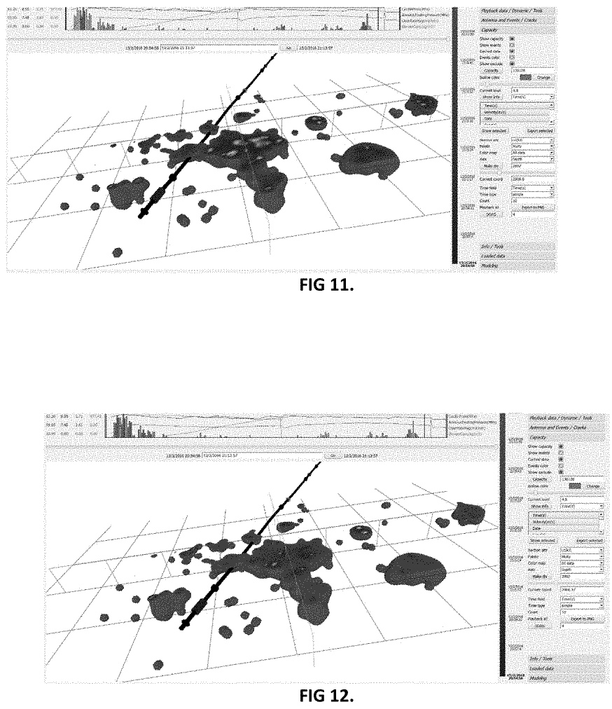

An important part of the microseismic control of the multi-stage fracturing mechanism is the estimation of stimulation reservoir volume (SRV)—Cippola et al., 2010. In this approach, unlike the conventional event-based approach, the SRV is estimated based on shear energy, separation/compression energy, hydrostatic energy, and total event energy at the same time. FIG. 10 shows the distribution of 354 events obtained during the monitoring of the 2nd stage of the multiple hydraulic fracturing. Based on the decomposition of the seismic moment tensor (SMT) for each event into components (DC) Double Couple, Compensated Linear Vector Dipole (CLVD) and Isotropic (ISO) are constructed corresponding SRV—FIG. 11-13.

Monitoring of Fluid Displacement.

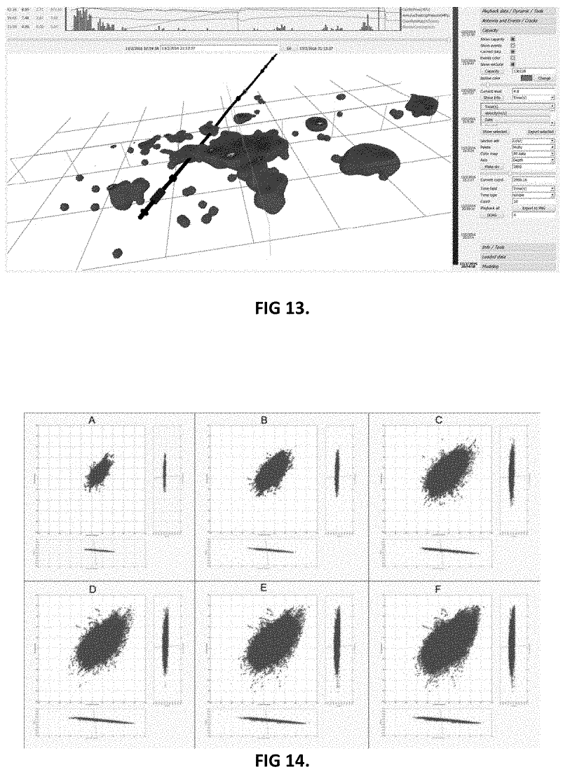

Determination of event hypocenters allows to observe fluid displacement by working agent in the vicinity of a wellbore. At the very beginning of fluid displacement we can observe the changes in seismic activity distribution dynamics over time (FIG. 14), and can determine the travelling direction of fluid displacement front.

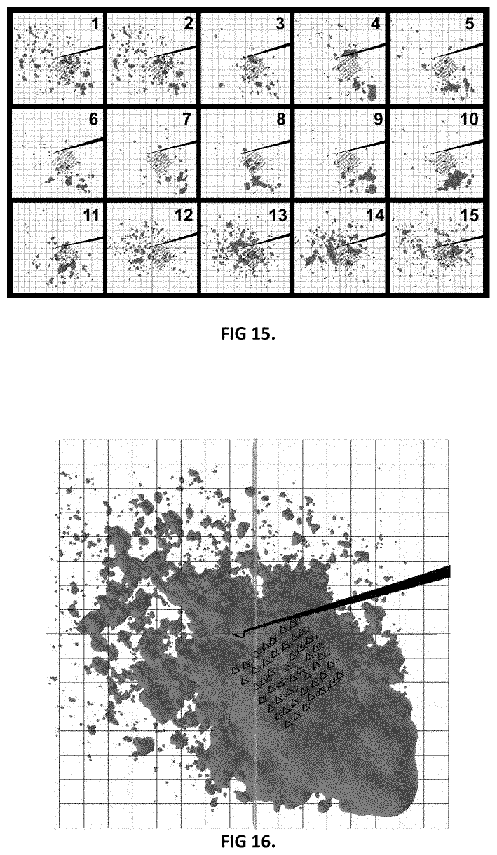

Next, we obtained seismic moment tensor from amplitude inversion of microseismic data, which enabled evaluation of energy parameters of the microseismic events, and, in turn, recognition of the microseismicity patterns caused by fluid injections. Based on the time-lapse microseismic data analysis (FIG. 15), the direction of injection water front movement (flood front) was determined. The microseismic events recorded for 15 days are presented in FIG. 16. Here the isosurface of the energy density of the microseismic events registered in the zone of the injection well of the hydrocarbon deposit within 15 days of observation is presented.

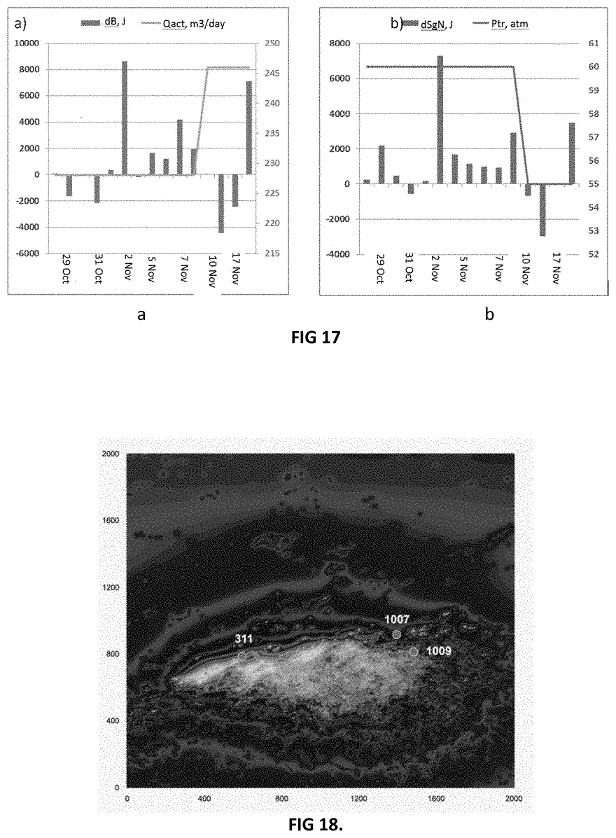

FIG. 17 represents daily injection volumes and injection pressure diagrams and overlaid bar chart of non-compensated parts of deformation energy of isotropic extension (dP) and maximum tensile (dSgN). Release of pressure and increase of water injection volume affects energy parameters.

Monitoring of slow-flowing processes can be associated with monitoring well feeding zones. For these processes, event distribution maps provide information on the micro deformations of the rock during fluid flow. This gives the interpreter knowledge of the zone involved in the formation of well production. The analysis of SMT allows to judge about the stress-strain state of the reservoir. Combining the latest information with information about the geological structure of the oil-bearing reservoir and the results of the analysis of the processes of influence on the reservoir makes it possible to identify the area actually involved in increasing the flow of oil (gas). Such an analysis makes it possible to formulate recommendations for the location of further activities for the intensification of hydrocarbon production.

Location of Active Zones.

Drainage areas of producing wells at the hydrocarbon fields provides useful and important information. FIG. 18 shows the area of the most intense microseismic activity that occurred during production from the porous reservoir without water stimulation (by natural pressure depletion).

Identification of Fault Block Structures.

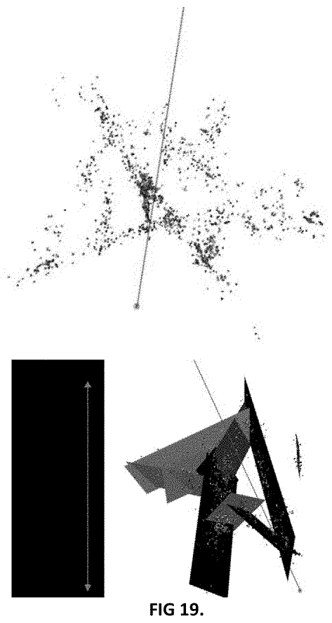

FIG. 19 represents microseismic monitoring results of hydrocarbon production by natural pressure depletion in the mixed type reservoir. The fault block structure near the producing well was delineated based on previous hydraulic fracturing monitoring.

Monitoring of Filtering Capacity.

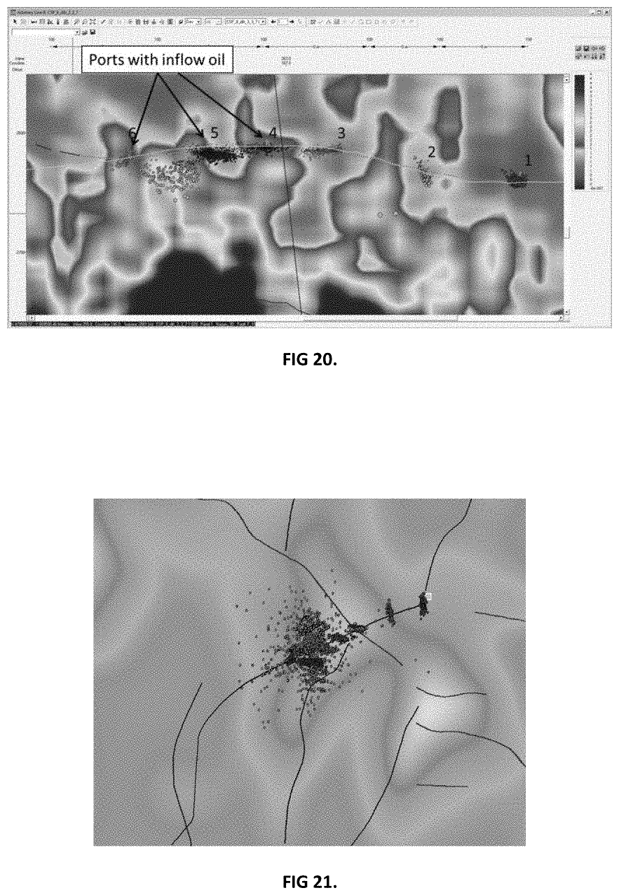

Multi-stage hydraulic fracturing (MHF) in horizontal wells is a well-known technology and currently is a widespread mechanism for hydrocarbon recovery. Traditionally, microseismic monitoring is applied for source characterization of microseismic events generated during a hydraulic-fracturing, however, this application does not provide information about the efficiency of each port. Passive monitoring performed after MHF (FIG. 20-21) allows recording microseismnic events near the producing ports. The investigations of fluid movement profiles in the well demonstrate that the only three producing ports in this zone were the ports where microseismic activity was observed.

The invention claimed is:

1. A system for acquiring microseismic data using compact mobile sensor array comprising: a high-density surface acquisition system for recording microseismic events for monitoring multi-stage hydraulic fracturing and for other technical operations (oil displacement, determining the displacement profile in the reservoir support system, well bottomhole treatment, gas lift, tracking the hydrodynamic coupling production wells, determination of flows in intercolumns at the emergency, etc.).

2. The system of claim 1, wherein dimensions of the receiving surface antenna are no more than a square with a side of 3000 ft.

3. The system of claim 1, wherein the density of sensors is at least 2 sensors/acre.

4. The system of claim 1, wherein the sensors of the receiving surface antenna are located on the surface on an irregular grid with an average distance between sensors from 90 ft to 150 ft.

5. The system of claim 1, wherein the sensors are single-component vertical geophones buried to a depth of 2-3 ft.

6. The system of claim 1, wherein the sampling time is no more than 0.5 ms.

7. The system of claim 1, wherein geographic coordinates of geophones are determined with an accuracy of no worse than 1 ft.

8. The system of claim 1 wherein the transfer time of 10% of the total number of microseismic antenna sensors to new antenna points does not exceed 1 hour.

9. The system of claim 1, wherein the method of continuous movement of a compact recording system (the principle of the roller), ensuring uninterrupted monitoring of multi-stage hydraulic fracturing for parallel horizontal wells (from 7 or more, up to 3500 ft long and distance between the wells up to 1000 ft).

10. The system of claim 1, wherein the guaranteed area of microseismic monitoring in the initial phase (without movement) is an area of 5000×5000 ft and a depth of 15000 ft.

11. A method for acquiring microseismic data using compact mobile sensor array comprising: deploying a plurality of sensors on the surface of the earth, the sensors being disposed above a selected subsurface volume; a high-density surface acquisition system for recording microseismic events for monitoring multi-stage hydraulic fracturing and for other technical operations (oil displacement, determining the displacement profile in the reservoir support system, well bottomhole treatment, gas lift, tracking the hydrodynamic coupling production wells, determination of flows in intercolumns at the emergency, etc.).

12. The method of claim 11 wherein the sensors are geophones.

13. The method of claim 11 wherein the sampling time is no more than 0.5 ms.

14. The method of claim 11, wherein geographic coordinates of geophones are determined with an accuracy of no worse than 1 ft.

15. The method of claim 11 wherein the transfer time of 10% of the total number of microseismic antenna sensors to new antenna points does not exceed 1 hour.

16. The method of claim 11 wherein the principle of rolling-continuous movement (displacement) of the antenna is carried out without stopping its work.

17. The method of claim 11, wherein the guaranteed area of microseismic monitoring in the initial phase (without movement) is an area of 5000×5000 ft and a depth of 15000 ft.

18. A method for microseismic data processing using compact mobile sensor array comprising: a high-density surface acquisition system for recording microseismic events for monitoring multi-stage hydraulic fracturing and for other technical operations (oil displacement, determining the displacement profile in the reservoir support system, well bottomhole treatment, gas lift, tracking the hydrodynamic coupling production wells, determination of flows in intercolumns at the emergency, etc.).

19. The method of claim 18, wherein mathematical methods of data processing recorded by a surface compact acquisition system allow to stably solve the inverse kinematic problem (determining the coordinates and the time) and the inverse dynamic problem (determining the seismic moment tensor) for the each event.

20. The method of claim 18, wherein is a hardware-software complex based on multi-core CPU/GPU hardware technologies for real-time processing of data from a compact high-density surface microseismnic monitoring system.

21. The method of claim 18, wherein the application software provides the calculation of the kinematic parameters (coordinates and time) and dynamic parameters (components of the seismic moment tensor) of microseismic events accompanying the multi-stage hydraulic fracturing in the real-time rate (no later than 2 minutes after the occurrence).

22. The method of claim 18, wherein provides results of monitoring every two minutes in a spatial parallelepiped which size are 1500×1500×300 ft and which is divided into elementary cubes (voxel) size 8×8×8 ft; in each elementary cube (voxel), the following are calculated: three principal stress vectors; the magnitude and direction of the minimum and maximum horizontal stresses; and three stresses values: shear—DC (Double Couple component of seismic moment tensor); tensile—CLVD (Compensated Linear Vector Dipole component of seismic moment tensor); explosive or implosive—ISO (Isotropic component of seismic moment tensor).

23. The method of claim 18, wherein four Stimulated Reservoir Volumes (SRV) are calculated every five minutes: SRV Energy; SRV DC; SRV CLVD; SRV ISO.
